(19) United States
(12) Patent Application Publication
(10) Pub. No.: US 2013/0041842 A1
(43) Pub. Date: Feb. 14, 2013

(54) COMPUTER IMPLEMENTED RISK MANAGED TREND INDICES

(71) Applicants: Andrew W. Lo, Weston, MA (US); Jeremiah H. Chafkin, Chestnut Hill, MA (US); Robert W. Sinnott, Boston, MA (US)

(72) Inventors: Andrew W. Lo, Weston, MA (US); Jeremiah H. Chafkin, Chestnut Hill, MA (US); Robert W. Sinnott, Boston, MA (US)

(21) Appl. No.: 13/208,423

(22) Filed: Aug. 12, 2011

(51) Int. Cl. G06Q 40/00

(52) U.S. Cl. 705/36 R

(57) ABSTRACT

The present invention provides for computer based systems and program controlled methods for reducing investors' exposure to the variability of an asset class's short-term volatility using long-short investing in a broad array of individual asset classes, with risk-controlled market exposures. This is achieved by constructing an index that employs a momentum portfolio policy, i.e. assets with prices that appear to be trending upward are held long, and those with prices that appear to be trending downward are sold short. This long-short policy is applied to each asset within broad asset class indices (equities, interest rates, commodities, and currencies), as well as within a multi-asset class composite index.

### FIELD OF THE INVENTION

The present invention is directed to computer systems and programming for implementing risk managed portfolios and investment vehicles. In addition, the present invention is directed to a program controlled computer system that facilitates implementing risk managed trend indices for select investments. The concepts herein supplement applicants' co-pending applications: U.S. patent application Ser. No. 12/387,898, filed on May 8, 2009, and “Computer Implemented Risk Managed Indices” filed concurrently herewith by the above inventors. Each of these disclosures is hereby incorporated into the application by reference thereto.

### BACKGROUND OF THE INVENTION

A set of passive, transparent, and investable indices have been designed with the goal of providing investors with risk-controlled access to a trend-following strategy that uses liquid exchange-traded futures contracts to obtain desired market exposures. The FTSE StableRisk Trend (SRT) Indices employ a momentum portfolio policy: assets with prices that appear to be trending upward are held long, and those with prices that appear to be trending downward are sold short. This long-short policy is applied to each asset within broad asset class indices (equities, interest rates, commodities, and currencies), as well as within a multi-asset class composite index. These indices are part of the FTSE StableRisk family, a larger collection of indices that share a common risk-control mechanism. This mechanism rebalances portfolio positions to a given volatility target as often as daily, which, we believe, yields more consistent volatility levels than portfolios with risk levels that are allowed to drift freely with the market's volatility. The StableRisk methodology is particularly important for trend-following strategies because of the dynamic nature of their volatility levels.

Investment Philosophy.

One of the well-established principles of modern finance is the risk/reward trade-off: the idea that riskier investments must offer a higher expected return so as to induce investors to bear higher expected risk. Of course, the precise nature of that risk matters in determining the magnitude of the corresponding risk premium. Idiosyncratic risk need not generate a positive risk premium because it can be eliminated through diversification. This simple but powerful idea has had far-reaching consequences both in academia and in practice. It provides the doctrine of motivation for passive investing. If assets with non-diversifiable risk carry a positive risk premium, it is possible to capture that premium in a low-cost, transparent, and scalable fashion by constructing a well-diversified buy-and-hold portfolio of risky assets.

This buy-and-hold approach to investing is predicated on the important assumption that the risk premium is stable and consistently positive. It is easy to see how such an assumption came to be made looking at the cumulative return of the S&P 500 from January 1926 to December 2008 (FIG. 1). Over the course of the last eight decades, the U.S. stock market has yielded an average annual return of 6.1% over short-term U.S. Treasury bills, with an annual standard deviation of 20.5%. With such a remarkable long-term track record for U.S. equities, a buy-and-hold strategy involving passively managed index funds is compelling, especially when compared to actively managed portfolios charging fees of 1% or more. Investing in “stocks for the long run” is perhaps the most basic form of a trend-following strategy—it is a bet that the trend in FIG. 1 will continue. Indeed, any investor of a passive buy-and-hold strategy is implicitly assuming a positive stable expected return to that strategy, i.e., a price trend.

While such an assumption may seem plausible in light of long-term U.S. economic growth, it is by no means certain, and the recent financial crisis—along with longer-term economic implications—suggests a more complex investment environment. Indeed, we need only look to Japan's Nikkei 225 Index in FIG. 2 to recognize that this assumption may not hold for extended periods of time.

Conventional trend-following strategies are based on a slightly more dynamic premise than traditional index products: expected returns are not constant, but vary over time, yet they persist to some degree. Therefore, just as periods of positive expected return call for a buy-and-hold policy, periods of negative expected return call for a short-sell-and-hold policy. The only subtlety is, of course, identifying the turning points, which trend-following strategies typically seek to accomplish by comparing long- and short-horizon moving averages.¹ The many possible indicators of turning points give rise to an equally diverse universe of trend-following strategies. ¹ For example, when the trailing 21-day moving-average price falls below the trailing 252-day moving-average price, this may be viewed as an indication that expected returns have become negative, which triggers a short position in the asset.

### OBJECTS AND SUMMARY OF THE PRESENT INVENTION

It is an object of the present invention to

It is a further object of the present invention to

The foregoing and other features of the present invention are further presented in conjunction with the following diagrams depicting a specific illustrative embodiment of the present invention of which:

### BRIEF DESCRIPTION OF THE FIGURES

FIG. 1 is the cumulative return of the S&P 500 total return index;

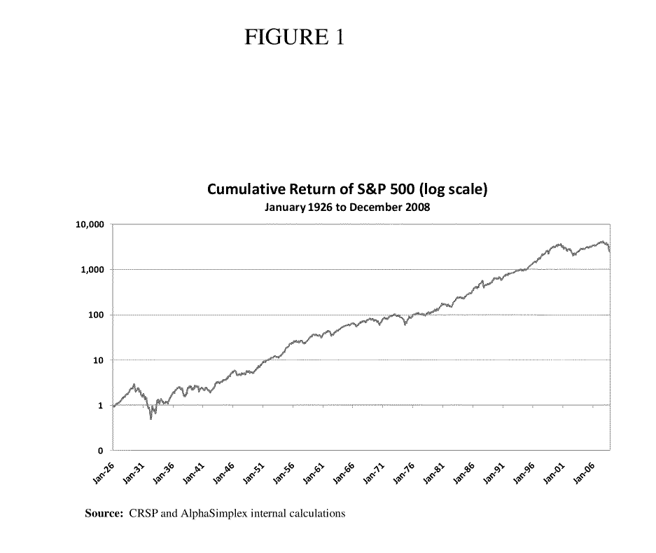

FIG. 2 is the cumulative return of the Nikkei 225 index;

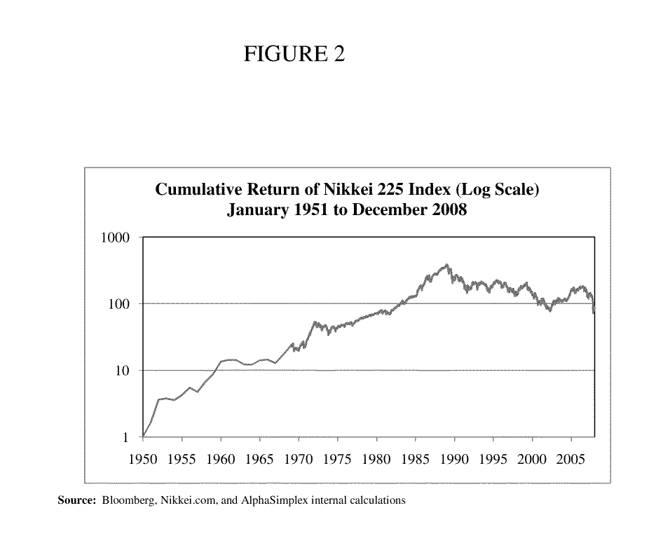

FIG. 3 is the cumulative returns of the StableRisk Trend Equity Index compared to traditional equity asset class benchmarks, over the period from January 1992 to August 2010;

FIG. 4 is the cumulative returns of the StableRisk Trend Commodity Index compared to traditional commodity asset class benchmarks, over the period from January 1992 to August 2010;

FIG. 5 is the cumulative returns of the StableRisk Trend Currency Index compared to the U.S. Dollar Index over the period from January 1992 to August 2010;

FIG. 6 is the cumulative returns of the StableRisk Trend Interest Rates Index compared to traditional bond and interest rate asset class benchmarks, over the period from January 1992 to August 2010;

FIG. 7 is the cumulative returns of the StableRisk Trend Composite Index over the period from January 1992 to August 2010;

FIG. 8 is the FTSE StableRisk Trend Indices component asset selection criteria;

FIG. 9 is the StableRisk Trend Composite Index's risk allocation methodology; and

FIG. 10 is an illustration of the process of calculating the FTSE StableRisk Trend Indices.

### DESCRIPTION OF THE INVENTION AND ILLUSTRATIVE EMBODIMENTS THEREOF

The purpose of the family of FTSE StableRisk Trend Indices is to provide investors with a passive strategy for long-short investing in a broad array of individual asset classes, with risk-controlled market exposures in a transparent framework.

Index Construction.

The FTSE StableRisk Trend Indices cover four asset classes: equities, commodities, interest rates, and currencies. Within each asset class, futures contracts are used to represent a market or an asset, and a separate FTSE StableRisk Trend Index is constructed for each asset class. A composite index representing all assets and asset classes is also computed. The specific futures contracts used to construct the indices are selected on the basis of their liquidity; only the most liquid contracts are employed so as to ensure that the indices are truly investable in large size (see Section 2). This liquidity threshold implies that the number of contracts represented in the indices may change over time. Sixty-nine assets are currently used to construct the indices (see Table A.1 in the Appendix for the specific contracts and their tickers):
Equities: Twenty-one global market index futures contracts.
Commodities: Twenty futures contracts consisting of two precious metal, four base metal, six energy, one livestock, and seven agricultural commodities futures contracts.
Currencies: Six currency futures contracts.
Interest Rates: Twenty-two futures contracts consisting of twelve global bond and ten global interest rate futures contracts.
Composite Index: All of the above.

The basic objective of the StableRisk Trend Indices is to provide long-short exposure (based on price momentum) to an asset with short-term volatility maintained at or near the long-term volatility level of the broader asset class at all times. This is attempted through the following process:
1. The eligible futures contracts are identified based on a minimum average daily dollar trading volume and regulatory restrictions.
2. The volatility target for each index is calculated annually using the trailing 10-year average volatility for a traditional long-only index representing that asset class. The volatility of each FTSE StableRisk Trend Index is stabilized at the long-term average volatility exhibited by its industry standard benchmark listed in Table 1. The short-term volatility of each index is stabilized at the target level described above by modulating the market exposure of each index. For example, if short-term market volatility were to double, the market exposure of the index would be halved.

TABLE 1
The traditional long-only indices on which the FTSE
StableRisk Trend Indices' long-term average volatility
benchmarks are based, along with their historical volatilities
from January 2000 to December 2009.
Long-Term Volatility Benchmarks of StableRisk Trend Indices

| | | Average Volatility |
|---|---|---|
| | | of Benchmark from |
| FTSE StableRisk | Long-Term Volatility | January 2000 to |
| Trend Index | Benchmark | December 2009 |
| Equity Index | FTSE All World Equity Index | 14.7% |
| Interest Rates | J. P. Morgan Hedged Global | 3.1% |
| Index | Government Bond Index | |
| Commodity Index | CRB—Reuters Jefferies | 14.8% |
| | Commodity Index | |
| Currency Index | Dollar Index | 7.9% |
| Composite Index | Fixed 15% Annualized Volatility | 15.0% |

3. The risk allocation among constituent assets is determined using a rules-based, systematic approach. Within each asset class, risk is allocated equally among countries (if relevant), and within each country, risk is allocated equally among all constituent contracts. For asset classes such as commodities, where countries are not relevant, risk is allocated equally among all constituent assets.
4. The assets' directional positions are determined using their trailing 1-month and 12-month prices. If the average daily price for the trailing 1-month period is higher than the average daily price for the trailing 12-month price, the trend is deemed to be positive. Positive trend assets are held long in the asset class index. If the average daily price for the trailing 1-month period is lower than the average daily price for the trailing 12-month price, the trend is deemed to be negative. Negative trend assets are held short in the asset class index.
5. The constituent asset weights are determined by combining the risk allocation information from Steps 2 and 3, and the directional information from Step 4, with short-term risk estimates (volatility and covariance) of each index's constituent assets. The result is an index whose risk is diversified equally across all constituent assets, and whose cumulative short-term volatility is stabilized at the long-term average volatility for the given asset class.
6. For the FTSE StableRisk Trend Composite Index, the short-term asset class volatility is used to rescale the risk allocation among the broad individual asset classes (stocks, commodities, currencies, and interest rates) in a process identical to Step 4, and the asset classes are then combined, using these risk allocations, into the Composite Index. This process ensures the Composite Index is maintained at or near its targeted volatility level at all times and that its risk is diversified equally across all asset classes, countries, and constituent contracts.
7. Because these indices involve more frequent rebalancing than traditional long-only buy-and-hold indices, we deduct trading costs when computing index returns (see Tables A.3 and A.4 in the Appendix for the assumed trading costs for each contract used in the indices).

Section 2 provides a more detailed explanation of the mechanics of index construction and maintenance. Full technical specifications of the indices are available on the FTSE website as part of its index rules documentation.

Historical Performance.

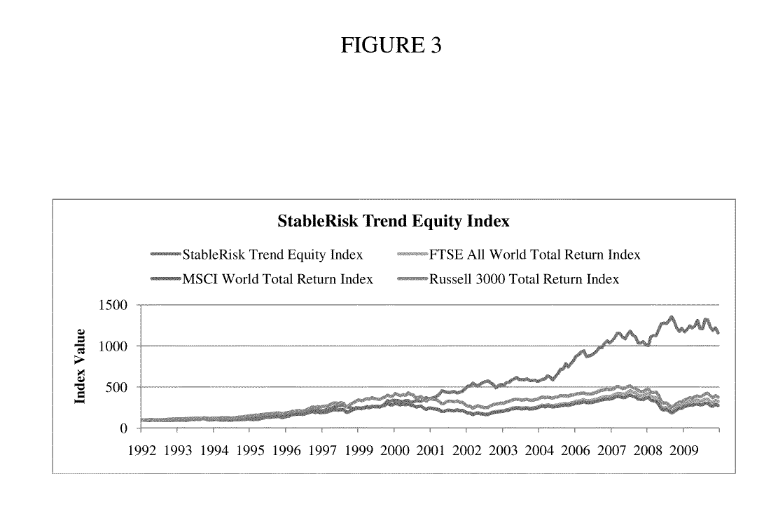

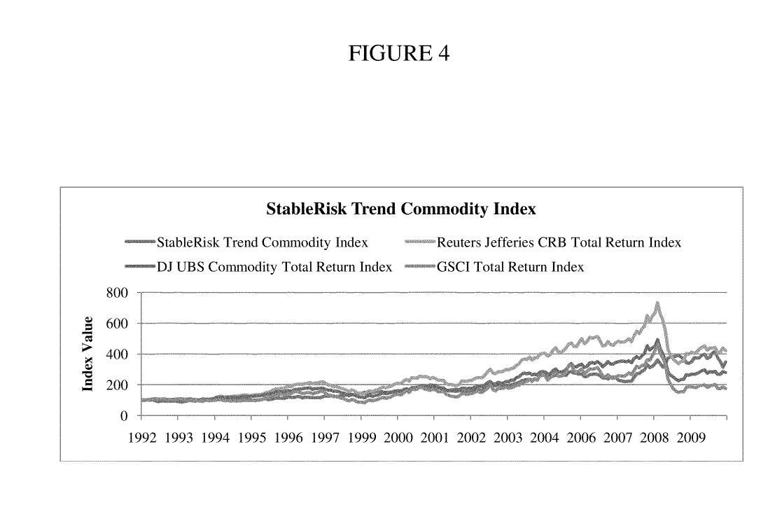

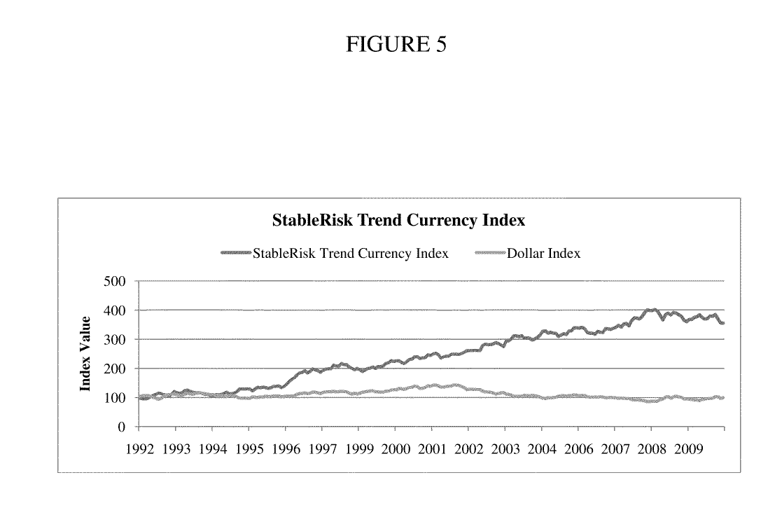

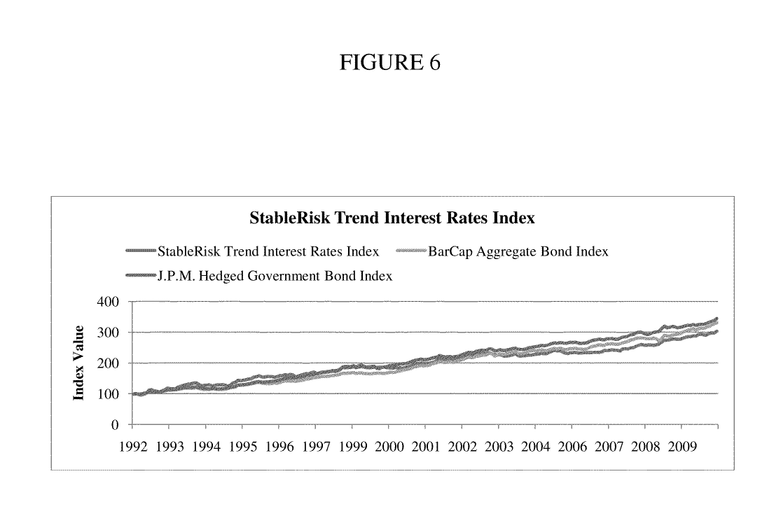

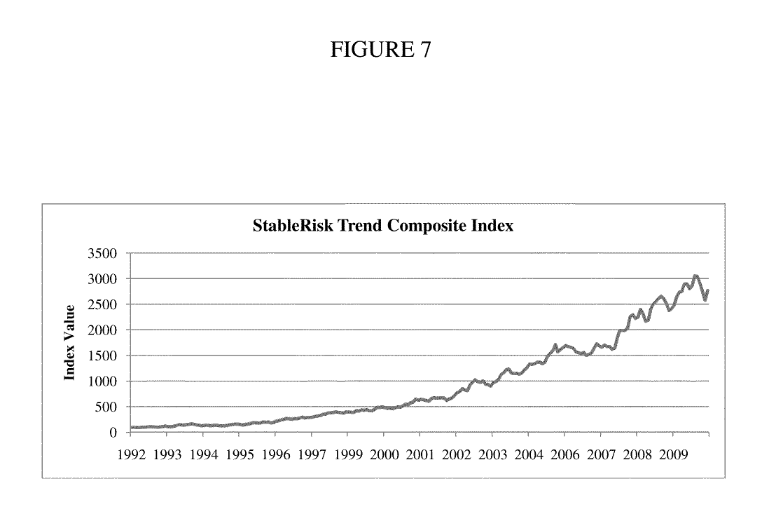

Tables 2-6 and FIGS. 3-7 summarize the historical performance of the StableRisk Trend Indices for various asset classes and composites from Jan. 1, 1992 to Aug. 31, 2010. The average return, volatility, maximum drawdown, and Sharpe ratios of the FTSE StableRisk Trend Indices are considered, along with those of the relevant traditional long-only benchmarks. In addition, the correlations of these indices with traditional, long-only investment benchmarks are shown in Table 7.

Over the sample period, the historical performance of the FTSE StableRisk Trend Indices compares favorably with their traditional long-only benchmarks, both in terms of risk-adjusted average returns and maximum drawdown. For example, the FTSE StableRisk Trend Equity Index has an average return of 14.0%, a volatility of 15.5%, and a maximum drawdown of −17.8%, significantly outperforming the FTSE All World Index which has an average return of 6.5%, a volatility of 15.4%, and a maximum drawdown of −54.5% during the same period.

The FTSE StableRisk Trend Commodity Index generated a slightly lower absolute return (6.9%) than the Reuters Jefferies CRB Index (8.0%) over the sample period, but a similar Sharpe ratio (0.25 for the SRT Commodity vs. 0.29 for the CRB), and a less severe maximum drawdown (−24.5% for the SRT Commodity vs. −54.0% for CRB) and very low correlation with traditional long-only commodity indices including the CRB, GSCI, and DJ UBS indices.

The FTSE StableRisk Trend Currency Index has an even higher absolute return and Sharpe ratio, and a maximum drawdown 24% better than that of the U.S. Dollar Index, and a correlation near zero to that same index.

However, with an average annual return of 6.1%, a volatility of 5.8%, a Sharpe ratio of 0.44, and a maximum drawdown of −7.8%, the FTSE StableRisk Trend Interest Rates Index underperforms the J.P. Morgan Hedged Government Bond Index, which has a 6.8% average annual return, 3.25% volatility, 1.02 Sharpe ratio, and −5.3% maximum drawdown during the same period. A significant portion of the underperformance may be due to the inclusion of transaction costs in the SRT index (which are generally not included in traditional bond indices) and the absence of any coupon income associated with the constituent bonds in a traditional bond index. The underperformance may also be partially attributable to the poor match between trend-following strategies and traditional, long-only bond indices; the popular traditional bond indices tend either to be currency-hedged or to include corporate as well as sovereign debt. In addition, the relatively uninterrupted decline in interest rates over the last three decades prevents trend-following from adding much value in this asset class.

Finally, the FTSE StableRisk Trend Composite Index yields an average annual return of 19.5%, an annual volatility of 16.4%, a Sharpe ratio of 0.97, and a maximum drawdown of −25.5% during the sample period. Its correlations to the FTSE All World, MSCI World, and Russell 3000 indices are −2.7%, −2.7%, and −4.2%, respectively, implying significant diversification benefits for portfolios of traditional long-only equity investments during the period from Jan. 1, 1992 to Aug. 31, 2010.

Index Applications.

The FTSE StableRisk Trend indices have the following characteristics:
Passive (rules-based) and transparent;
Investable and replicable;
Broadly-diversified within and across asset classes;
Long-short indices based on a simple, well-documented trend-following investment process.

These characteristics make them well-suited for the following three applications:
1. Investment Vehicles. The FTSE StableRisk Trend indices are investable and replicable and can easily serve as the basis for creating high-capacity, low-cost investment vehicles to gain exposure to asset classes at stable risk levels.
2. Portfolio Structuring. More risk-efficient portfolio structures may be created by allocating some portion of the strategic or policy asset class allocations to vehicles linked to these indices. This would allow investors to reduce the overall portfolio's sensitivity to changes in short-term risk and potentially to reduce the maximum drawdown of the portfolio by relaxing the long-only constraint without sacrificing long-term expected returns.
3. Benchmarking. The FTSE StableRisk Trend indices—and customized variations with different target volatilities and/or constituent weights—can be used as performance benchmarks for long-short strategies that invest within and across asset classes, globally.

TABLE 2
Comparison of the StableRisk Trend Equity Index and the
FTSE All World Equity Index performance over the period
from January 1992 through August 2010.
StableRisk Trend Equity Index

| January 1992- | StableRisk Trend | StableRisk | FTSE All World |
|---|---|---|---|
| August 2010 | Equity Index | Equity Index | Equity Index* |
| Mean Return | 14.0% | 7.8% | 6.5% |
| Standard Deviation | 15.5% | 16.3% | 15.4% |
| Sharpe Ratio^{§} | 0.67 | 0.26 | 0.19 |
| Max. Drawdown | −17.8% | −49.0% | −54.5% |

*The FTSE All World Equity Index is proxied prior to 1994 by the MSCI World Index.
^{§}Sharpe Ratio is calculated using the 3-month T-bill yield as the riskless rate of return.

TABLE 3
Comparison of the StableRisk Trend Commodity Index and the
Reuters Jefferies CRB Index performance over the period
from January 1992 through August 2010.
StableRisk Trend Commodity Index

| | | | Reuters |
|---|---|---|---|
| January 1992- | StableRisk Trend | StableRisk | Jefferies |
| August 2010 | Commodity Index | Commodity Index | CRB Index |
| Mean Return | 6.9% | 8.9% | 8.0% |
| Standard Deviation | 13.7% | 13.0% | 15.5% |
| Sharpe Ratio^{§} | 0.25 | 0.41 | 0.29 |
| Max. Drawdown | −24.5% | −29.6% | −54.0% |

^{§}Sharpe Ratio is calculated using the 3-month T-bill yield as the riskless rate of return.

TABLE 4
Comparison of the StableRisk Trend Currency Index and the
U.S. Dollar Index performance over the period
from January 1992 through August 2010.
StableRisk Trend Currency Index

| January 1992- | StableRisk Trend | StableRisk | Dollar |
|---|---|---|---|
| August 2010 | Currency Index | Currency Index | Index |
| Mean Return | 7.0% | 3.8% | 0.0% |
| Standard Deviation | 9.2% | 9.2% | 8.3% |
| Sharpe Ratio^{§} | 0.38 | 0.03 | −0.43 |
| Max. Drawdown | −16.8% | −32.5% | −40.3% |

^{§}Sharpe Ratio is calculated using the 3-month T-bill yield as the riskless rate of return.

TABLE 5
Comparison of the StableRisk Trend Interest Rates Index and the
J. P. Morgan Hedged Government Bond Index performance over
the period from January 1992 through August 2010.
StableRisk Trend Interest Rates Index

| | | | J. P. Morgan |
|---|---|---|---|
| | StableRisk Trend | StableRisk | Hedged |
| January 1992- | Interest | Interest | Government |
| August 2010 | Rates Index | Rates Index | Bond Index* |
| Mean Return | 6.1% | 6.7% | 6.8% |
| Standard Deviation | 5.8% | 5.6% | 3.3% |
| Sharpe Ratio^{§} | 0.44 | 0.57 | 1.02 |
| Max. Drawdown | −7.8% | −10.2% | −5.3% |

*The J. P. Morgan Bond Index is proxied prior to 1993 by the BarCap Aggregate Bond Index.
^{§}Sharpe Ratio is calculated using the 3-month T-bill yield as the riskless rate of return

TABLE 6
Performance statistics for the StableRisk Trend Composite
Index for the period from January 1992 through August 2010.
StableRisk Trend Composite Index

| January 1992- | StableRisk Trend | StableRisk |
|---|---|---|
| August 2010 | Composite Index | Composite Index |
| Mean Return | 19.5% | 17.1% |
| Standard Deviation | 16.4% | 17.2% |
| Sharpe Ratio^{§} | 0.97 | 0.79 |
| Max. Drawdown | −25.5% | −24.3% |

^{§}Sharpe Ratio is calculated using the 3-month T-bill yield as the riskless rate of return.

TABLE 7
Selected historical correlations of the FTSE StableRisk Trend Indices with traditional benchmarks
during the period January 1995 through December 2009. The shorter period, from 1995 through 2009,
is used to include only series that have complete historical data during this period.
Historical Correlations of StableRisk Trend Indices and Traditional Benchmarks

| | StableRisk Trend | StableRisk Trend | StableRisk Trend | StableRisk Trend | StableRisk Trend |
|---|---|---|---|---|---|
| January 1995-August 2010 | Currency Index | Equity Index | Interest Rates Index | Commodity Index | Composite Index |
| Dollar Index | 2.6% | 16.4% | −10.6% | 3.1% | −0.2% |
| StableRisk Trend Currency Index | — | 28.6% | 5.1% | 18.3% | 63.7% |
| StableRisk Currency Index | −1.4% | −16.8% | 10.1% | 1.6% | 0.4% |
| FTSE All World Total Return Index | 5.1% | 7.9% | −11.0% | −16.5% | −2.7% |
| MSCI World Total Return Index | 5.4% | 8.7% | −10.9% | −16.8% | −2.7% |
| Russell 3000 Total Return Index | 6.0% | 10.1% | −10.9% | −18.3% | −4.2% |
| StableRisk Trend Equity Index | 28.6% | — | 6.8% | 8.2% | 59.1% |
| StableRisk Equity Index | 14.7% | 41.8% | −4.1% | −8.8% | 18.8% |
| BarCap Aggregate Bond Index | 9.7% | −3.9% | 52.2% | −6.4% | 22.4% |
| J. P. M. Hedged Government Bond Index | 16.8% | 3.5% | 65.7% | 3.9% | 34.8% |
| StableRisk Trend Interest Rates Index | 5.1% | 6.8% | — | −3.5% | 39.5% |
| StableRisk Interest Rates Index | 8.3% | 5.2% | 78.3% | 2.2% | 34.3% |
| CRB Total Return Index | 3.5% | 3.1% | −4.5% | 17.4% | 9.6% |
| DJ UBS Commodity Total Return Index | 5.3% | 5.5% | −1.1% | 16.1% | 12.5% |
| GSCI Total Return Index | 0.4% | 2.9% | −2.1% | 22.9% | 11.6% |
| StableRisk Trend Commodity Index | 18.3% | 8.2% | −3.5% | — | 57.8% |
| StableRisk Commodity Index | 1.8% | −0.2% | −3.1% | 24.9% | 9.9% |
| 3-Month T-Bill | 14.0% | 13.0% | 7.6% | −2.1% | 6.1% |
| StableRisk Trend Composite Index | 63.7% | 59.1% | 39.5% | 57.8% | — |
| StableRisk Composite Index | 13.0% | 12.7% | 41.4% | 7.9% | 31.1% |

### Index Construction and Maintenance Methodology

In this section, the detailed, but non-technical, index construction methodology is described. The methodology is identical to that of the original, long-only FTSE StableRisk Indices with regard to contract selection, risk allocation, and index calculation. However, the additional step of determining trend direction, and positive or negative exposure to each asset, has been added to the index calculation process and is described.

Contract Selection.

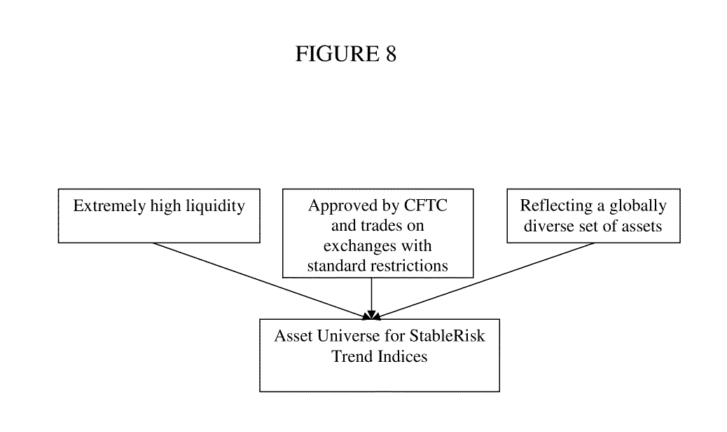

The futures contracts used in these indices are chosen using several criteria based on the practical implications of their trading. For a futures contract to be included, it must both be approved by the CFTC and traded on an exchange that does not impose inordinately complex or stringent requirements. Such determinations are made by the Index Committee. An example of a futures contract that at the time of this publication, is excluded based on this qualitative restriction is the Korean three-year bond future, which, although it meets the volume requirements is traded on an exchange that requires pre-funding and does not permit give-ups.² The contract selection process is illustrated in FIG. 8. ² “Give-ups” are futures trades executed with different brokers that are later consolidated with one brokerage house for clearing.

In addition to the regulatory and exchange requirements for inclusion, each futures contract must have an average total aggregate daily trading volume in its component contracts (that is, volume across all currently traded contracts within a contract series) of at least one billion USD. Average daily trading volume for this purpose is calculated annually based on the prior twelve months, on December 31st, or another date as determined by the Index Committee. Contracts currently passing all the above filters and qualifying for inclusion in the Indices are listed in the Appendix (Table A.1). Once included, a contract is not removed from the index until its average daily volume drops below 500 million USD. The above volume filters are more conservative than the inclusion criteria used by many traditional indices, and were determined without reference to possible index performance implications.

Trend Direction.

The basic algorithm for determining the desired direction for each asset position is the same across all asset classes. Please note this step only occurs in the StableRisk Trend Indices.
1. For each asset, calculate the simple moving 252-day average and the simple moving 21-day average of its price series, after accounting for contract rolling effects. Then calculate the percentage difference between the above two moving averages, in terms of the 252-day moving average value. The choice of time horizons (1 month and 1 year) is consistent with our preference for commonly-used and intuitive parameters.
2. For each asset on each trading day, if the 252-day average is above the 21-day average by more than a specific threshold percentage as described later, target a short position in this asset. If the 252-day average is below the 21-day average by more than a specific threshold percentage, target a long position in this asset. If neither of the above occurs, target the same position direction targeted for the most recently calculated trading day, i.e., the previous trading day of that asset.
3. Each year, for each asset, look back on the previous 10 years' returns, and compare them to the returns that would have been generated if different asset-specific percentage thresholds were used. If that asset's returns would have been better with a different threshold, use the better threshold for the coming year for that particular asset. In practice, this is modeled using a grid of possible thresholds, and is compared using the geometric Sharpe ratio statistic.

Risk Allocation.

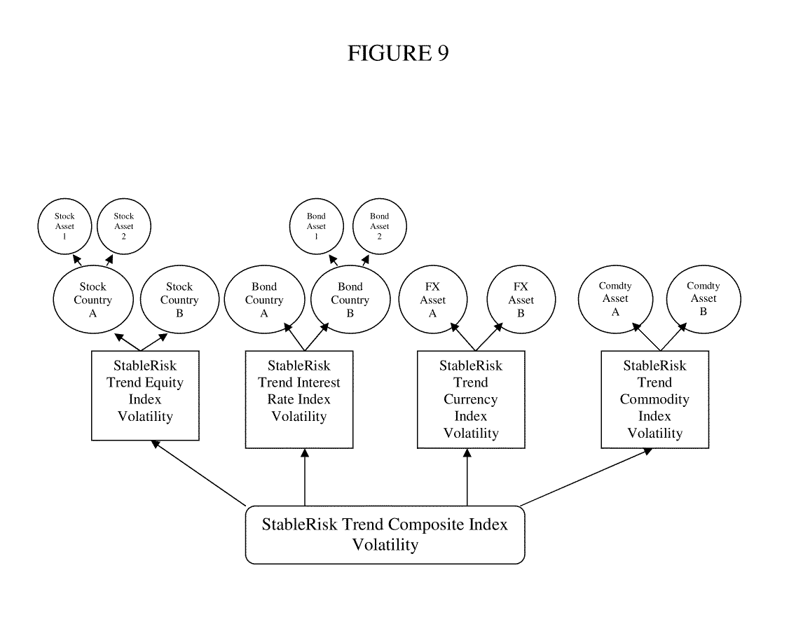

The process for determining the risk allocation of the indices to each of their constituent assets is illustrated in FIG. 9. The goal of the approach is two-fold: (1) to have each asset class index and the composite index target their short-term volatility to their respective volatility benchmark shown in Table 1; (2) to distribute the risk of each of these indices among their constituent assets in an equal and proportional way, taking into account geographic commonality. The process used by the StableRisk Trend Indices to allocate risk exposure is as follows:
1. Normalize Asset Risk. Normalize the weights of all of the constituent assets so that their short-term volatilities are targeted to the same value.
2. Normalize Asset Risk for Country Groups. For each asset in an “asset group” (i.e., assets, within a specific asset class, that represent equity or bond markets within a single country), divide the normalized weights by the number of assets in the asset group so that each country has the same total risk weight. (E.g., there are five U.S. equity markets in the index, so each would have their normalized weights divided by 5.) These weights are shown in Table A.2 of the Appendix.
3. Scale Asset Class Portfolio Volatility. Estimate the short-term volatility of the asset class index portfolios, taking covariances and long-short positions into account, and scale all the asset weights such that the asset class portfolio's estimated short-term volatility matches its volatility target. Because of the extremely low volatility of the short-term (3-month or less) interest rate contracts, the StableRisk Trend Interest Rates Index targets portfolio volatility for the short-term interest rates and the longer bond contracts separately as two sub-portfolios, and then combines them with a 50%/50% risk weighting.
4. Combine Asset Class Portfolios into the Composite Index. For the StableRisk Trend Composite Index, apply Steps 2 and 3 again, treating all of the assets within an asset class as an “asset group,” and combining all of the asset class portfolios together such that each asset class has equal risk allocation, and the overall composite portfolio's short-term volatility targets its volatility benchmark.

Index Calculation.

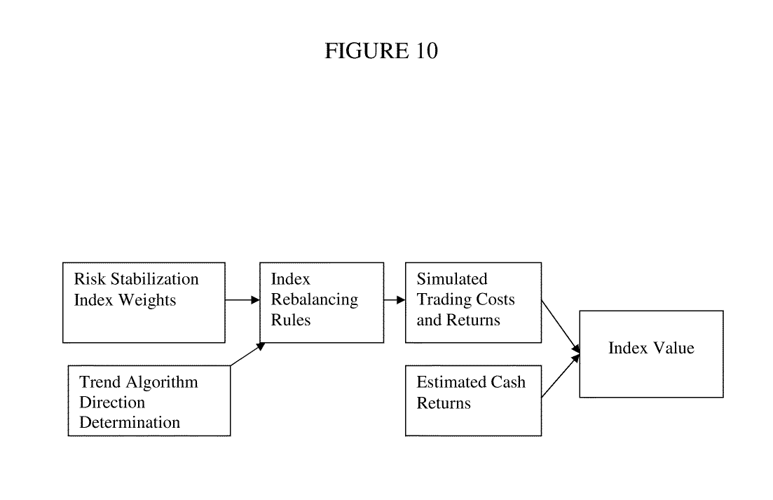

The following steps are taken in order to make the returns of the SRT indices more consistent with the returns that would be realized by an investment strategy using a similar methodology, and are illustrated in FIG. 10:
1. Portfolio Rebalancing Rules. Because short-term volatility targeting leads to significant turnover, rebalancing thresholds are used to limit position changes to those over a threshold of 25% of the previous position. The result is slightly more variability in volatility relative to the target, but substantially reduced turnover.
2. Transaction Costs. While the restriction to highly liquid contracts does reduce transaction costs, the relatively high turnover of this index cannot be ignored. As such, transaction costs accounting for trading commissions and market impact are used. The assumed costs are shown in the appendix (Tables A.3 and A.4). These values are calculated assuming that only whole contracts are traded, and that the index portfolios have a value of 100 million USD at all times.
3. Cash Returns. Futures contracts are agreements for future delivery of an asset, and not actually the holding of an asset, requiring only that cash be held as margin. Capital not required for margin is assumed to be held as cash earning interest based on current money market and interbank rates. As such, the returns on this cash are simulated as the 1-month LIBOR rate on 80% of the portfolio value, and added to the index.

### Theoretical and Empirical Underpinnings

Time-Varying Expected Returns.

There is considerable academic research documenting the existence of time-varying expected returns and statistical shifts in regimes in financial asset prices,³ with a multitude of potential explanations for such time variation in returns and risk levels. In particular, a great deal of empirical research supports the idea that momentum and trend-following strategies earn significant abnormal returns across many markets. The history of these and other “technical” trading strategies is long, going back several decades (see, for example, Cootner, 1964; Fama and Blume, 1966). More recent studies include: Jegadeesh and Titman (1993), the papers in Lo (1997), and Conrad and Kaul (1998) who show that momentum strategies appear to provide abnormal returns in U.S. stocks. Papers by Rouwenhorst (1998), Moskowitz (1999), and Chan, Hameed, and Tong (2000) document similar results for European stocks, U.S. industrial sectors, and country-wide stock indices, respectively. ³ See, for example, Ang and Bekaert (2002), Campbell and Shiller (1988), Chordia and Shivakumar (2002), Fama and French (1988, 1989), and Ferson and Harvey (1991).

Trend-Following and Momentum.

Institutional trading practices such as stop-loss policies, delta-hedging option-replication strategies, and algorithmic order-placement strategies all contribute to price momentum. Theoretical models of economic equilibrium in which market participants have asymmetric private information that is costly to gather and disseminated only gradually also imply trends in asset prices. Similar conclusions follow from models of the business cycle, learning behavior, and behavioral patterns such as herding, confirmation bias, mental models, and overconfidence.

Trend-Following in Commodities.

Within the field of commodities and futures trading, a separate trend-following literature has developed.⁴ One of the earliest studies of trends and momentum in commodities is Roberts (1959), which considers the possibility that commodities-based technical trading strategies are little more than statistical artifacts of the random variation in commodity prices. A more recent study by Erb and Harvey (2006) has shown that trend-following strategies in actively-managed commodity futures portfolios do better than simple buy-and-hold commodities portfolios. ⁴ Applications of technical trading rules in equities have come under heavy criticism due to trading costs, which are considerably higher than in the futures markets. For example, one of the most well-known rules-based active stock trading anomalies, involving the Dow Jones Industrial Average, was documented by Brock, Lakonishok, and LeBaron (1992), and Bessembinder and Chan (1998) find that the strategy's apparent profits do not exceed the transaction costs required to implement the strategy. Futures contracts are considerably less expensive to trade, as noted by Locke and Venkatesh (1997) who estimate that transaction costs for futures contracts are in the range of 0.4 to 3.3 basis points, as calculated by Marshall, Cahan, and Cahan (2008). For the purposes of the FTSE StableRisk Trend Indices, we believe these estimates to be approximately an order of magnitude too small after accounting for market-impact effects. However, even after adjusting for such effects, the trading costs associated with futures contracts are still significantly below the 1.2% to 10.5% estimated for stocks by Lesmond, Ogden, and Trzcinka (1999).

In an attempt to address the “over-fitting” or “data-snooping” bias in these findings, Miffre and Riallis (2007) demonstrate that the equities-based momentum strategies of Jegadeesh and Titman (1993) also perform well with commodities, even after 1993, yielding an “out-of-sample” test of the Jegadeesh and Titman (1993) result on a different asset class. Szakmary, Shen, and Sharma (2010) provide additional evidence for the benefits of trend-following strategies.

Diversification Benefits.

More generally, there is an extensive literature on the benefits of diversifying investment portfolios by including commodities, currencies, and other non-traditional asset classes. For example, Gorton (2005) shows that holding a long position in commodities through the Goldman Sachs Commodities Index (GSCI) slightly decreases the average return of traditional stock and bond portfolios but more than commensurately decreases their volatility. However, Gorton (2005) only considers long-only commodities positions; an earlier study by Vrugt, Bauer, Molenaar, and Steenkamp (2004) demonstrates that by using active and dynamic rules-based strategies that rely on macro-economic data, e.g., business cycles, monetary policy, and market sentiment, even greater diversification and return benefits can be added to a portfolio through actively-managed commodity futures.

Similar results have been documented in technical trading strategies by Schneeweis and Spurgin (1996), Erb and Harvey (2006), and Szakmary, Shen, and Sharma (2010). Several authors have attempted to explain why commodities are able to provide such diversification benefits. Gorton (2005) attributes these benefits to their apparent inflation-hedging abilities, which was also observed by Bodie (1983) years earlier.

Skeptics.

There are, of course, skeptics of trend-following and momentum strategies. For example, Koracjczyk and Sadka (2004) find that many momentum strategies in stocks would not be profitable prior to the decimalization of stock prices in 2001 because of the magnitude of transaction costs. Lesmond, Schill, and Zhou (2004) also note that many equity momentum strategies rely unduly on the ability to cheaply short small-cap stocks, which is not always feasible in practice.

Others criticize the historical profitability of trend-following strategies as examples of data-snooping biases, good outcomes that are spurious and unlikely to perform well out-of-sample. Using Sullivan, Timmerman, and White (1999) and White's (2000) “reality check” bootstrap procedure to adjust for backtest bias, Marshall, Cahan, and Cahan (2008) show that fourteen of the fifteen commodities no longer exhibit statistically significant momentum profits.⁵ More broadly, Szakmary, Shen, and Sharma (2010) note that those technical strategies with the greatest following may only be popular because investors have been able to identify the historical pattern easily. ⁵ However, note that Szakmary, Shen, and Sharma (2010) criticizes the findings in Marshall, Cahan, and Cahan (2008) because the tests were conducted asset by asset, not at the portfolio level.

Even with these caveats, we believe that trend-following does correspond to a persistent and systematic source of risk and expected return. Therefore, passive, low-cost, rules-based, risk-controlled, trend-following strategies do have the potential, in our opinion, to add value to traditional investment portfolios.

Backtest, Survivorship, and Data-Snooping Biases.

While the simulated historical performance figures of the FTSE StableRisk Trend Indices appear compelling, they should be treated with a certain degree of skepticism because of the impact of backtest, survivorship, and data-snooping biases that can affect any empirical analysis of investment performance employing historical data. Since certain investment products may exhibit attractive historical returns simply due to chance, it is important to understand the rationale for superior performance and not rely solely on historical returns.

At the same time, historical results cannot be ignored because they do contain useful information about an investment product's realized returns during specific periods in the market's past. For example, in comparing two investment strategies, most investors today would insist on understanding the relative performance of the two strategies during the fourth quarter of 2008, one of the most challenging periods for financial markets since 1929. Such results are, of course, still subject to backtest bias like any other empirical study of past performance—for example, the better-performing strategy may simply have been short S&P 500 futures, not because of an active bet, but due to a policy of maintaining a consistently low market beta. Nevertheless, the historical differences in realized returns may also signal significant differences in the strategies' portfolio construction processes, risk management protocols, and liquidity characteristics.

In short, historical performance is a double-edged sword that may overstate the performance benefits of an investment strategy, but can also provide us with valuable information about risk and reward. The challenge is, of course, separating signal from noise, which can only be done through a combination of quantitative and qualitative processes that include judgment, intuition, experience, and a fully articulated investment rationale. See Leamer (1978), Lo and MacKinlay (1990), and Lo (1994, 2010) for more detailed discussions of backtest bias.

### EXAMPLES

TABLE A.1
Information detailing the futures contracts which compose the StableRisk Trend Indices.
Contracts Included in the StableRisk Trend Indices, by Index as of 2010

| Futures Contract Name | Bloomberg Ticker | Currency | Exchange | Contract Months | Country | Index* |
|---|---|---|---|---|---|---|
| 10-Year Commonwealth Treasury Bond Futures | XMA Comdty | AUD | SFE | HMUZ | AUS | Interest Rates Index |
| 2-Year US Treasury Note Futures | TUA Comdty | USD | CBT | HMUZ | USA | Interest Rates Index |
| 3-Month (Short) Sterling Interest Rate Futures | LA Comdty | GBP | LIF-NYSE | HMUZ | UK | Interest Rates Index |
| 3-Month Euro Euribor Interest Rate Futures | ERA Comdty | EUR | LIF-NYSE | HMUZ | EU | Interest Rates Index |
| 3-Month Euro Swiss Franc Interest Rate Futures | ESA Comdty | CHF | LIF-NYSE | HMUZ | SWI | Interest Rates Index |
| 3-Month Euroyen Futures | YEA Comdty | JPY | TFX | HMUZ | JAP | Interest Rates Index |
| 3-Year Commonwealth Treasury Bond Futures | YMA Comdty | AUD | SFE | HMUZ | AUS | Interest Rates Index |
| 30-Day Federal Fund Rate Futures | FFA Comdty | USD | CBT | FGHJKMNQUVXZ | USA | Interest Rates Index |
| 30-Day ASX Interbank Cash Rate Futures | IBA Comdty | AUD | SFE | FGHJKMNQUVXZ | AUS | Interest Rates Index |
| 90-Day EuroDollar Time Deposit Futures | EDA Comdty | USD | CME | HMUZ | USA | Interest Rates Index |
| ASX 90-Day Bank Accepted Bills Futures | IRA Comdty | AUD | SFE | HMUZ | AUS | Interest Rates Index |
| 5-Year US Treasury Note Futures | FVA Comdty | USD | CBT | HMUZ | USA | Interest Rates Index |
| Canadian 10 Year Bond Futures | CAN Comdty | CAD | MSE | HMUZ | CAN | Interest Rates Index |
| Canadian 3-Month Bankers Acceptance Futures | BAA Comdty | CAD | MSE | HMUZ | CAN | Interest Rates Index |
| Euro-Bobl Bond Futures | OEA Comdty | EUR | EUX | HMUZ | EU | Interest Rates Index |
| Euro-Bund Bond Futures | RXA Comdty | EUR | EUX | HMUZ | EU | Interest Rates Index |
| Euro-Schatz Bond Futures | DUA Comdty | EUR | EUX | HMUZ | EU | Interest Rates Index |
| Japanese 10-Year Bond Futures (JGB) | JBA Comdty | JPY | TSE | HMUZ | JAP | Interest Rates Index |
| Long Gilt Futures | GA Comdty | GBP | LIF-NYSE | HMUZ | UK | Interest Rates Index |
| New Zealand 90-Day Bank Bill Futures | ZBA Comdty | NZD | SFE | HMUZ | NZ | Interest Rates Index |
| US 10-Year Treasury Note Futures | TYA Comdty | USD | CBT | HMUZ | USA | Interest Rates Index |
| US 30-Year Long Bond Futures | USA Comdty | USD | CBT | HMUZ | USA | Interest Rates Index |
| Brent Crude Oil Futures | COA Comdty | USD | ICE | FGHJKMNQUVXZ | — | Commodity Index |
| Coffee ‘C’ Futures | KCA Comdty | USD | NYB-ICE | HKNUZ | — | Commodity Index |
| Copper Futures | LPA Comdty | USD | LME | FGHJKMNQUVXZ | — | Commodity Index |
| Corn Futures | CA Comdty | USD | CBT | HMUZ | — | Commodity Index |
| Gasoil (IPE) Futures | QSA Comdty | USD | ICE | FGHJKMNQUVXZ | — | Commodity Index |
| Gasoline RBOB Futures** | XBA Comdty | USD | NYM | FGHJKMNQUVXZ | — | Commodity Index |
| Gold 100 Oz Futures | GCA Comdty | USD | CMX | GJMQVZ | — | Commodity Index |
| Heating Oil Futures | HOA Comdty | USD | NYM | FGHJKMNQUVXZ | — | Commodity Index |
| Live Cattle Futures | LCA Comdty | USD | CME | GJMQVZ | — | Commodity Index |
| Natural Gas Futures | NGA Comdty | USD | NYM | FGHJKMNQUVXZ | — | Commodity Index |
| Primary Nickel Futures | LNA Comdty | USD | LME | FGHJKMNQUVXZ | — | Commodity Index |
| Primary Aluminum Futures | LAA Comdty | USD | LME | FGHJKMNQUVXZ | — | Commodity Index |
| Silver 5000 Oz Futures | SIA Comdty | USD | CMX | FHKNUZ | — | Commodity Index |
| Soybean Futures | SA Comdty | USD | CBT | FHKNQUX | — | Commodity Index |
| Soybean Meal Futures | SMA Comdty | USD | CBT | FHKNQUVZ | — | Commodity Index |
| Soybean Oil Futures | BOA Comdty | USD | CBT | FHKNQUVZ | — | Commodity Index |
| Sugar #11 Futures | SBA Comdty | USD | NYB-ICE | HKNV | — | Commodity Index |
| Wheat Futures | WA Comdty | USD | CBT | HKNUZ | — | Commodity Index |
| WTI Crude Oil Futures | CLA Comdty | USD | NYM | FGHJKMNQUVXZ | — | Commodity Index |
| Zinc Futures | LXA Comdty | USD | LME | FGHJKMNQUVXZ | — | Commodity Index |
| Amsterdam Exchange Index Futures | EOA Index | EUR | EOE | FGHJKMNQUVXZ | NDL | Equity Index |
| CAC 40 10 Euro Index Futures | CFA Index | EUR | EOP | FGHJKMNQUVXZ | FRA | Equity Index |
| DAX Index Futures | GXA Index | EUR | EUX | HMUZ | GER | Equity Index |
| E-mini Dow Jones Industrial Average Futures | DMA Index | USD | CBT | HMUZ | USA | Equity Index |
| E-mini NASDAQ 100 Index Futures | NQA Index | USD | CME | HMUZ | USA | Equity Index |
| E-mini S&P 500 Index Futures | ESA Index | USD | CME | HMUZ | USA | Equity Index |
| E-mini S&P Midcap 400 Futures | FAA Index | USD | CME | HMUZ | USA | Equity Index |
| EURO STOXX 50 Index Futures | VGA Index | EUR | EUX | HMUZ | EU | Equity Index |
| FTSE 100 Index Futures | ZA Index | GBP | LIF-NYSE | HMUZ | UK | Equity Index |
| FTSE JSE Top 40 Index Futures | AIA Index | ZAR | SAF | HMUZ | S.AF | Equity Index |
| FTSE MIB Index Futures | STA Index | EUR | MIL | HMUZ | ITL | Equity Index |
| Hang Seng Enterprise Index Futures | HCA Index | HKD | HKG | FGHJKMNQUVXZ | HK | Equity Index |
| Hang Seng Index Futures | HIA Index | HKD | HKG | HMUZ | HK | Equity Index |
| IBEX 35 Index Futures | IBA Index | EUR | MFM | FGHJKMNQUVXZ | SPA | Equity Index |
| MSCI Taiwan Stock Index Futures | TWA Index | USD | SGX | FGHJKMNQUVXZ | TWA | Equity Index |
| Nikkei 225 (OSE) Index Futures | NKA Index | JPY | OSE | HMUZ | JAP | Equity Index |
| OMXS30 Index Futures | QCA Index | SEK | SSE-OMX | FGHJKMNQUVXZ | SWE | Equity Index |
| E-mini Russell 200 Index Futures | RTAA Index | USD | NYF-ICE | HMUZ | USA | Equity Index |
| S&P TSX 60 Index Futures | PTA Index | CAD | MSE | HMUZ | CAN | Equity Index |
| ASX SPI 200 Index Futures | XPA Index | AUD | SFE | HMUZ | AUS | Equity Index |
| TOPIX Index Futures | TPA Index | JPY | TSE | HMUZ | JAP | Equity Index |
| Australian Dollar Futures | ADA Curncy | USD | CME | HMUZ | AUS | Currency Index |
| British Pounds Sterling Futures | BPA Curncy | USD | CME | HMUZ | GBP | Currency Index |
| Canadian Dollar Futures | CDA Curncy | USD | CME | HMUZ | CAD | Currency Index |
| Euro Futures | ECA Curncy | USD | CME | HMUZ | EUR | Currency Index |
| Japanese Yen Futures | JYA Curncy | USD | CME | HMUZ | JAP | Currency Index |
| Swiss Franc Futures | SFA Curncy | USD | CME | HMUZ | CHF | Currency Index |

*The Composite Index contains all of the above contracts.
**The RBOB gasoline contract is proxied by the NY Unleaded gasoline (HUA Comdty) prior to September 2006.

TABLE A.2
The weights in this table are the risk weight multipliers for each contract, by year. An entry
specifies that the contract was included in the index in a given year. A non-unitary entry implies that the
contract is part of a country group, as discussed in Section 2.
Contract Risk Weights, By Year

| Futures Contract Name | Index* | 2000 | 2001 | 2002 | 2003 | 2004 | 2005 | 2006 | 2007 | 2008 | 2009 | 2010 |
|---|---|---|---|---|---|---|---|---|---|---|---|---|
| 10-Year Commonwealth Treasury Bond Futures | Interest Rates Index | 0.5 | 0.5 | 0.5 | 0.5 | 0.5 | 0.5 | 0.5 | 0.5 | 0.5 | 0.5 | 0.5 |
| 2-Year US Treasury Note Futures | Interest Rates Index | 0.25 | 0.25 | 0.25 | 0.25 | 0.25 | 0.25 | 0.25 | 0.25 | 0.25 | 0.25 | 0.25 |
| 3-Month (Short) Sterling Interest Rate Futures | Interest Rates Index | 1 | 1 | 1 | 1 | 1 | 1 | 1 | 1 | 1 | 1 | 1 |
| 3-Month Euro Euribor Interest Rate Futures | Interest Rates Index | 1 | 1 | 1 | 1 | 1 | 1 | 1 | 1 | 1 | 1 | 1 |
| 3-Month Euro Swiss Franc Interest Rate Futures | Interest Rates Index | 1 | 1 | 1 | 1 | 1 | 1 | 1 | 1 | 1 | 1 | 1 |
| 3-Month Euroyen Futures | Interest Rates Index | 1 | 1 | 1 | 1 | 1 | 1 | 1 | 1 | 1 | 1 | 1 |
| 3-Year Commonwealth Treasury Bond Futures | Interest Rates Index | 0.5 | 0.5 | 0.5 | 0.5 | 0.5 | 0.5 | 0.5 | 0.5 | 0.5 | 0.5 | 0.5 |
| 30-Day Federal Fund Rate Futures | Interest Rates Index | 1 | 1 | 1 | 1 | 1 | 1 | 1 | 1 | 1 | 1 | 1 |
| 30-Day ASX Interbank Cash Rate Futures | Interest Rates Index | | | | | | | 0.5 | 0.5 | 0.5 | 0.5 | 0.5 |
| 90-Day EuroDollar Time Deposit Futures | Interest Rates Index | 1 | 1 | 1 | 1 | 1 | 1 | 1 | 1 | 1 | 1 | 1 |
| ASX 90-Day Bank Accepted Bills Futures | Interest Rates Index | 1 | 1 | 1 | 1 | 1 | 1 | 0.5 | 0.5 | 0.5 | 0.5 | 0.5 |
| 5-Year US Treasury Note Futures | Interest Rates Index | 0.25 | 0.25 | 0.25 | 0.25 | 0.25 | 0.25 | 0.25 | 0.25 | 0.25 | 0.25 | 0.25 |
| Canadian 10 Year Bond Futures | Interest Rates Index | | | | | | 1 | 1 | 1 | 1 | 1 | 1 |
| Canadian 3-Month Bankers Acceptance Futures | Interest Rates Index | 1 | 1 | 1 | 1 | 1 | 1 | 1 | 1 | 1 | 1 | 1 |
| Euro-Bobl Bond Futures | Interest Rates Index | 0.33 | 0.33 | 0.33 | 0.33 | 0.33 | 0.33 | 0.33 | 0.33 | 0.33 | 0.33 | 0.33 |
| Euro-Bund Bond Futures | Interest Rates Index | 0.33 | 0.33 | 0.33 | 0.33 | 0.33 | 0.33 | 0.33 | 0.33 | 0.33 | 0.33 | 0.33 |
| Euro-Schatz Bond Futures | Interest Rates Index | 0.33 | 0.33 | 0.33 | 0.33 | 0.33 | 0.33 | 0.33 | 0.33 | 0.33 | 0.33 | 0.33 |
| Japanese 10-Year Bond Futures (JGB) | Interest Rates Index | 1 | 1 | 1 | 1 | 1 | 1 | 1 | 1 | 1 | 1 | 1 |
| Long Gilt Futures | Interest Rates Index | 1 | 1 | 1 | 1 | 1 | 1 | 1 | 1 | 1 | 1 | 1 |
| New Zealand 90-Day Bank Bill Futures | Interest Rates Index | 1 | 1 | 1 | 1 | 1 | 1 | 1 | 1 | 1 | 1 | 1 |
| US 10-Year Treasury Note Futures | Interest Rates Index | 0.25 | 0.25 | 0.25 | 0.25 | 0.25 | 0.25 | 0.25 | 0.25 | 0.25 | 0.25 | 0.25 |
| US 30-Year Long Bond Futures | Interest Rates Index | 0.25 | 0.25 | 0.25 | 0.25 | 0.25 | 0.25 | 0.25 | 0.25 | 0.25 | 0.25 | 0.25 |
| Brent Crude Oil Futures | Commodity Index | 1 | 1 | 1 | 1 | 1 | 1 | 1 | 1 | 1 | 1 | 1 |
| Coffee ‘C’ Futures | Commodity Index | | | | | | | | | 1 | 1 | 1 |
| Copper Futures | Commodity Index | | | | | | | 1 | 1 | 1 | 1 | 1 |
| Corn Futures | Commodity Index | 1 | 1 | 1 | 1 | 1 | 1 | 1 | 1 | 1 | 1 | 1 |
| Gasoil (IPE) Futures | Commodity Index | | | | | | 1 | 1 | 1 | 1 | 1 | 1 |
| Gasoline RBOB Futures** | Commodity Index | 1 | 1 | 1 | 1 | 1 | 1 | 1 | 1 | 1 | 1 | 1 |
| Gold 100 Oz Futures | Commodity Index | 1 | 1 | 1 | 1 | 1 | 1 | 1 | 1 | 1 | 1 | 1 |
| Heating Oil Futures | Commodity Index | | 1 | 1 | 1 | 1 | 1 | 1 | 1 | 1 | 1 | 1 |
| Live Cattle Futures | Commodity Index | | | | | | | | 1 | 1 | 1 | 1 |
| Natural Gas Futures | Commodity Index | 1 | 1 | 1 | 1 | 1 | 1 | 1 | 1 | 1 | 1 | 1 |
| Primary Nickel Futures | Commodity Index | | | | | | | | | 1 | 1 | 1 |
| Primary Aluminum Futures | Commodity Index | | | | | | | 1 | 1 | 1 | 1 | 1 |
| Silver 5000 Oz Futures | Commodity Index | | | | | | | | 1 | 1 | 1 | 1 |
| Soybean Futures | Commodity Index | 1 | 1 | 1 | 1 | 1 | 1 | 1 | 1 | 1 | 1 | 1 |
| Soybean Meal Futures | Commodity Index | | | | | | | | | 1 | 1 | 1 |
| Soybean Oil Futures | Commodity Index | | | | | | | | | 1 | 1 | 1 |
| Sugar #11 Futures | Commodity Index | | | | | | | | 1 | 1 | 1 | 1 |
| Wheat Futures | Commodity Index | | | | | | | | 1 | 1 | 1 | 1 |
| WTI Crude Oil Futures | Commodity Index | 1 | 1 | 1 | 1 | 1 | 1 | 1 | 1 | 1 | 1 | 1 |
| Zinc Futures | Commodity Index | | | | | | | | 1 | 1 | 1 | 1 |
| Amsterdam Exchange Index Futures | Equity Index | 1 | 1 | 1 | 1 | 1 | 1 | 1 | 1 | 1 | 1 | 1 |
| CAC 40 10 Euro Index Futures | Equity Index | 1 | 1 | 1 | 1 | 1 | 1 | 1 | 1 | 1 | 1 | 1 |
| DAX Index Futures | Equity Index | 1 | 1 | 1 | 1 | 1 | 1 | 1 | 1 | 1 | 1 | 1 |
| E-mini Dow Jones Industrial Average Futures | Equity Index | 0.5 | .33 | 0.33 | 0.33 | 0.33 | 0.33 | 0.25 | 0.25 | 0.25 | 0.2 | 0.2 |
| E-mini NASDAQ 100 Index Futures | Equity Index | | .33 | 0.33 | 0.33 | 0.33 | 0.33 | 0.25 | 0.25 | 0.25 | 0.2 | 0.2 |
| E-mini S&P 500 Index Futures | Equity Index | 0.5 | .33 | 0.33 | 0.33 | 0.33 | 0.33 | 0.25 | 0.25 | 0.25 | 0.2 | 0.2 |
| E-mini S&P Midcap 400 Futures | Equity Index | | | | | | | 0.25 | 0.25 | 0.25 | 0.2 | 0.2 |
| EURO STOXX 50 Index Futures | Equity Index | | 1 | 1 | 1 | 1 | 1 | 1 | 1 | 1 | 1 | 1 |
| FTSE 100 Index Futures | Equity Index | 1 | 1 | 1 | 1 | 1 | 1 | 1 | 1 | 1 | 1 | 1 |
| FTSE JSE Top 40 Index Futures | Equity Index | | | | | | | | 1 | 1 | 1 | 1 |
| FTSE MIB Index Futures | Equity Index | | | | | | | 1 | 1 | 1 | 1 | 1 |
| Hang Seng Enterprise Index Futures | Equity Index | | | | | | | | | 0.5 | 0.5 | 0.5 |
| Hang Seng Index Futures | Equity Index | 1 | 1 | 1 | 1 | 1 | 1 | 1 | 1 | 0.5 | 0.5 | 0.5 |
| IBEX 35 Index Futures | Equity Index | | 1 | 1 | 1 | 1 | 1 | 1 | 1 | 1 | 1 | 1 |
| MSCI Taiwan Stock Index Futures | Equity Index | | | | | | | | | 1 | 1 | 1 |
| Nikkei 225 (OSE) Index Futures | Equity Index | 0.5 | 0.5 | 0.5 | 0.5 | 0.5 | 0.5 | 0.5 | 0.5 | 0.5 | 0.5 | 0.5 |
| OMXS30 Index Futures | Equity Index | | | | | | | | 1 | 1 | 1 | 1 |
| E-mini Russell 200 Index Futures | Equity Index | | | | | | | | | | 0.2 | 0.2 |
| S&P TSX 60 Index Futures | Equity Index | | | | | | | | 1 | 1 | 1 | 1 |
| ASX SPI 200 Index Futures | Equity Index | | | | | | 1 | 1 | 1 | 1 | 1 | 1 |
| TOPIX Index Futures | Equity Index | 0.5 | 0.5 | 0.5 | 0.5 | 0.5 | 0.5 | 0.5 | 0.5 | 0.5 | 0.5 | 0.5 |
| Australian Dollar Futures | Currency Index | | | | | | | 1 | 1 | 1 | 1 | 1 |
| British Pounds Sterling Futures | Currency Index | 1 | 1 | 1 | 1 | 1 | 1 | 1 | 1 | 1 | 1 | 1 |
| Canadian Dollar Futures | Currency Index | | | | | 1 | 1 | 1 | 1 | 1 | 1 | 1 |
| Euro Futures | Currency Index | 1 | 1 | 1 | 1 | 1 | 1 | 1 | 1 | 1 | 1 | 1 |
| Japanese Yen Futures | Currency Index | 1 | 1 | 1 | 1 | 1 | 1 | 1 | 1 | 1 | 1 | 1 |
| Swiss Franc Futures | Currency Index | 1 | 1 | 1 | 1 | 1 | 1 | 1 | 1 | 1 | 1 | 1 |

*The Composite Index contains all of the above contracts.
**The RBOB gasoline contract is proxied by the NY Unleaded gasoline (HUA Comdty) prior to September 2006.

TABLE A.3
Market impact cost assumptions used in the StableRisk Trend Indices, for the years 2000 through
2010. These costs are listed in basis points (one-hundredth of a percent), and are assumed to be the cost of
trading each contract, due to bid-ask spread, and temporary price displacement due to the transaction.
Market Impact Costs, By Contract, by Year, in Basis Points

| Futures Contract Name | Index* | 2000 | 2001 | 2002 | 2003 | 2004 | 2005 | 2006 | 2007 | 2008 | 2009 | 2010 |
|---|---|---|---|---|---|---|---|---|---|---|---|---|
| 10-Year Commonwealth Treasury | Interest Rates Index | 2.35 | 2.2 | 2.05 | 1.9 | 1.75 | 1.6 | 1.45 | 1.3 | 1.15 | 1 | 1 |
| Bond Futures | | | | | | | | | | | | |
| 2-Year US Treasury Note Futures | Interest Rates Index | 2.35 | 2.2 | 2.05 | 1.9 | 1.75 | 1.6 | 1.45 | 1.3 | 1.15 | 1 | 1 |
| 3-Month (Short) Sterling Interest | Interest Rates Index | 2.35 | 2.2 | 2.05 | 1.9 | 1.75 | 1.6 | 1.45 | 1.3 | 1.15 | 1 | 1 |
| Rate Futures | | | | | | | | | | | | |
| 3-Month Euro Euribor Interest | Interest Rates Index | 2.35 | 2.2 | 2.05 | 1.9 | 1.75 | 1.6 | 1.45 | 1.3 | 1.15 | 1 | 1 |
| Rate Futures | | | | | | | | | | | | |
| 3-Month Euro Swiss Franc Interest | Interest Rates Index | 2.35 | 2.2 | 2.05 | 1.9 | 1.75 | 1.6 | 1.45 | 1.3 | 1.15 | 1 | 1 |
| Rate Futures | | | | | | | | | | | | |
| 3-Month Euroyen Futures | Interest Rates Index | 2.35 | 2.2 | 2.05 | 1.9 | 1.75 | 1.6 | 1.45 | 1.3 | 1.15 | 1 | 1 |
| 3-Year Commonwealth Treasury | Interest Rates Index | 2.35 | 2.2 | 2.05 | 1.9 | 1.75 | 1.6 | 1.45 | 1.3 | 1.15 | 1 | 1 |
| Bond Futures | | | | | | | | | | | | |
| 30-Day Federal Fund Rate Futures | Interest Rates Index | 2.35 | 2.2 | 2.05 | 1.9 | 1.75 | 1.6 | 1.45 | 1.3 | 1.15 | 1 | 1 |
| 30-Day ASX Interbank Cash | Interest Rates Index | 2.35 | 2.2 | 2.05 | 1.9 | 1.75 | 1.6 | 1.45 | 1.3 | 1.15 | 1 | 1 |
| Rate Futures | | | | | | | | | | | | |
| 90-Day EuroDollar Time | Interest Rates Index | 2.35 | 2.2 | 2.05 | 1.9 | 1.75 | 1.6 | 1.45 | 1.3 | 1.15 | 1 | 1 |
| Deposit Futures | | | | | | | | | | | | |
| ASX 90-Day Bank Accepted | Interest Rates Index | 2.35 | 2.2 | 2.05 | 1.9 | 1.75 | 1.6 | 1.45 | 1.3 | 1.15 | 1 | 1 |
| Bills Futures | | | | | | | | | | | | |
| 5-Year US Treasury Note Futures | Interest Rates Index | 2.35 | 2.2 | 2.05 | 1.9 | 1.75 | 1.6 | 1.45 | 1.3 | 1.15 | 1 | 1 |
| Canadian 10 Year Bond Futures | Interest Rates Index | 7.05 | 6.6 | 6.15 | 5.7 | 5.25 | 4.8 | 4.35 | 3.9 | 3.45 | 3 | 3 |
| Canadian 3-Month Bankers | Interest Rates Index | 2.35 | 2.2 | 2.05 | 1.9 | 1.75 | 1.6 | 1.45 | 1.3 | 1.15 | 1 | 1 |
| Acceptance Futures | | | | | | | | | | | | |
| Euro-Bobl Bond Futures | Interest Rates Index | 2.35 | 2.2 | 2.05 | 1.9 | 1.75 | 1.6 | 1.45 | 1.3 | 1.15 | 1 | 1 |
| Euro-Bund Bond Futures | Interest Rates Index | 2.35 | 2.2 | 2.05 | 1.9 | 1.75 | 1.6 | 1.45 | 1.3 | 1.15 | 1 | 1 |
| Euro-Schatz Bond Futures | Interest Rates Index | 2.35 | 2.2 | 2.05 | 1.9 | 1.75 | 1.6 | 1.45 | 1.3 | 1.15 | 1 | 1 |
| Japanese 10-Year Bond Futures | Interest Rates Index | 2.35 | 2.2 | 2.05 | 1.9 | 1.75 | 1.6 | 1.45 | 1.3 | 1.15 | 1 | 1 |
| (JGB) | | | | | | | | | | | | |
| Long Gilt Futures | Interest Rates Index | 2.35 | 2.2 | 2.05 | 1.9 | 1.75 | 1.6 | 1.45 | 1.3 | 1.15 | 1 | 1 |
| New Zealand 90-Day Bank | Interest Rates Index | 2.35 | 2.2 | 2.05 | 1.9 | 1.75 | 1.6 | 1.45 | 1.3 | 1.15 | 1 | 1 |
| Bill Futures | | | | | | | | | | | | |
| US 10-Year Treasury Note Futures | Interest Rates Index | 2.35 | 2.2 | 2.05 | 1.9 | 1.75 | 1.6 | 1.45 | 1.3 | 1.15 | 1 | 1 |
| US 30-Year Long Bond Futures | Interest Rates Index | 2.35 | 2.2 | 2.05 | 1.9 | 1.75 | 1.6 | 1.45 | 1.3 | 1.15 | 1 | 1 |
| Brent Crude Oil Futures | Commodity Index | 14.80 | 13.86 | 12.91 | 11.97 | 11.02 | 10.08 | 9.135 | 8.19 | 7.245 | 6.3 | 6.3 |
| Coffee ‘C’ Futures | Commodity Index | 15.74 | 14.74 | 13.73 | 12.73 | 11.72 | 10.72 | 9.715 | 8.71 | 7.705 | 6.7 | 6.7 |
| Copper Futures | Commodity Index | 12.69 | 11.88 | 11.07 | 10.26 | 9.45 | 8.64 | 7.83 | 7.02 | 6.21 | 5.4 | 5.4 |
| Corn Futures | Commodity Index | 22.56 | 21.12 | 19.68 | 18.24 | 16.8 | 15.36 | 13.92 | 12.48 | 11.04 | 9.6 | 9.6 |
| Gasoil (IPE) Futures | Commodity Index | 31.72 | 29.7 | 27.67 | 25.65 | 23.62 | 21.6 | 19.57 | 17.55 | 15.52 | 13.5 | 13.5 |
| Gasoline RBOB Futures** | Commodity Index | 12.93 | 12.1 | 11.275 | 10.45 | 9.625 | 8.8 | 7.975 | 7.15 | 6.325 | 5.5 | 5.5 |
| Gold 100 Oz Futures | Commodity Index | 18.56 | 17.38 | 16.19 | 15.01 | 13.82 | 12.64 | 11.45 | 10.27 | 9.085 | 7.9 | 7.9 |
| Heating Oil Futures | Commodity Index | 19.03 | 17.82 | 16.60 | 15.39 | 14.17 | 12.96 | 11.74 | 10.53 | 9.315 | 8.1 | 8.1 |
| Live Cattle Futures | Commodity Index | 18.33 | 17.16 | 15.99 | 14.82 | 13.65 | 12.48 | 11.31 | 10.14 | 8.97 | 7.8 | 7.8 |
| Natural Gas Futures | Commodity Index | 13.16 | 12.32 | 11.48 | 10.64 | 9.8 | 8.96 | 8.12 | 7.28 | 6.44 | 5.6 | 5.6 |
| Primary Nickel Futures | Commodity Index | 13.39 | 12.54 | 11.68 | 10.83 | 9.975 | 9.12 | 8.265 | 7.41 | 6.555 | 5.7 | 5.7 |
| Primary Aluminum Futures | Commodity Index | 13.87 | 12.98 | 12.10 | 11.21 | 10.33 | 9.44 | 8.555 | 7.67 | 6.785 | 5.9 | 5.9 |
| Silver 5000 Oz Futures | Commodity Index | 32.9 | 30.8 | 28.7 | 26.6 | 24.5 | 22.4 | 20.3 | 18.2 | 16.1 | 14 | 14 |
| Soybean Futures | Commodity Index | 13.63 | 12.76 | 11.89 | 11.02 | 10.15 | 9.28 | 8.41 | 7.54 | 6.67 | 5.8 | 5.8 |
| Soybean Meal Futures | Commodity Index | 24.67 | 23.1 | 21.52 | 19.95 | 18.37 | 16.8 | 15.22 | 13.65 | 12.07 | 10.5 | 10.5 |
| Soybean Oil Futures | Commodity Index | 22.09 | 20.68 | 19.27 | 17.86 | 16.45 | 15.04 | 13.63 | 12.22 | 10.81 | 9.4 | 9.4 |
| Sugar #11 Futures | Commodity Index | 35.25 | 33 | 30.75 | 28.5 | 26.25 | 24 | 21.75 | 19.5 | 17.25 | 15 | 15 |
| Wheat Futures | Commodity Index | 18.8 | 17.6 | 16.4 | 15.2 | 14 | 12.8 | 11.6 | 10.4 | 9.2 | 8 | 8 |
| WTI Crude Oil Futures | Commodity Index | 14.1 | 13.2 | 12.3 | 11.4 | 10.5 | 9.6 | 8.7 | 7.8 | 6.9 | 6 | 6 |
| Zinc Futures | Commodity Index | 27.02 | 25.3 | 23.57 | 21.85 | 20.12 | 18.4 | 16.67 | 14.95 | 13.22 | 11.5 | 11.5 |
| Amsterdam Exchange Index Futures | Equity Index | 11.75 | 11 | 10.25 | 9.5 | 8.75 | 8 | 7.25 | 6.5 | 5.75 | 5 | 5 |
| CAC 40 10 Euro Index Futures | Equity Index | 4.7 | 4.4 | 4.1 | 3.8 | 3.5 | 3.2 | 2.9 | 2.6 | 2.3 | 2 | 2 |
| DAX Index Futures | Equity Index | 2.35 | 2.2 | 2.05 | 1.9 | 1.75 | 1.6 | 1.45 | 1.3 | 1.15 | 1 | 1 |
| E-mini Dow Jones Industrial | Equity Index | 9.4 | 8.8 | 8.2 | 7.6 | 7 | 6.4 | 5.8 | 5.2 | 4.6 | 4 | 4 |
| Average Futures | | | | | | | | | | | | |
| E-mini NASDAQ 100 Index Futures | Equity Index | 4.7 | 4.4 | 4.1 | 3.8 | 3.5 | 3.2 | 2.9 | 2.6 | 2.3 | 2 | 2 |
| E-mini S&P 500 Index Futures | Equity Index | 2.35 | 2.2 | 2.05 | 1.9 | 1.75 | 1.6 | 1.45 | 1.3 | 1.15 | 1 | 1 |
| E-mini S&P Midcap 400 Futures | Equity Index | 9.4 | 8.8 | 8.2 | 7.6 | 7 | 6.4 | 5.8 | 5.2 | 4.6 | 4 | 4 |
| EURO STOXX 50 Index Futures | Equity Index | 11.75 | 11 | 10.25 | 9.5 | 8.75 | 8 | 7.25 | 6.5 | 5.75 | 5 | 5 |
| FTSE 100 Index Futures | Equity Index | 5.875 | 5.5 | 5.125 | 4.75 | 4.375 | 4 | 3.625 | 3.25 | 2.875 | 2.5 | 2.5 |
| FTSE JSE Top 40 Index Futures | Equity Index | 7.05 | 6.6 | 6.15 | 5.7 | 5.25 | 4.8 | 4.35 | 3.9 | 3.45 | 3 | 3 |
| FTSE MIB Index Futures | Equity Index | 2.35 | 2.2 | 2.05 | 1.9 | 1.75 | 1.6 | 1.45 | 1.3 | 1.15 | 1 | 1 |
| Hang Seng Enterprise Index Futures | Equity Index | 9.4 | 8.8 | 8.2 | 7.6 | 7 | 6.4 | 5.8 | 5.2 | 4.6 | 4 | 4 |
| Hang Seng Index Futures | Equity Index | 4.7 | 4.4 | 4.1 | 3.8 | 3.5 | 3.2 | 2.9 | 2.6 | 2.3 | 2 | 2 |
| IBEX 35 Index Futures | Equity Index | 14.1 | 13.2 | 12.3 | 11.4 | 10.5 | 9.6 | 8.7 | 7.8 | 6.9 | 6 | 6 |
| MSCI Taiwan Stock Index Futures | Equity Index | 21.15 | 19.8 | 18.45 | 17.1 | 15.75 | 14.4 | 13.05 | 11.7 | 10.35 | 9 | 9 |
| Nikkei 225 (OSE) Index Futures | Equity Index | 30.55 | 28.6 | 26.65 | 24.7 | 22.75 | 20.8 | 18.85 | 16.9 | 14.95 | 13 | 13 |
| OMXS30 Index Futures | Equity Index | 18.8 | 17.6 | 16.4 | 15.2 | 14 | 12.8 | 11.6 | 10.4 | 9.2 | 8 | 8 |
| E-mini Russell 200 Index Futures | Equity Index | 7.05 | 6.6 | 6.15 | 5.7 | 5.25 | 4.8 | 4.35 | 3.9 | 3.45 | 3 | 3 |
| S&P TSX 60 Index Futures | Equity Index | 11.75 | 11 | 10.25 | 9.5 | 8.75 | 8 | 7.25 | 6.5 | 5.75 | 5 | 5 |
| ASX SPI 200 Index Futures | Equity Index | 7.05 | 6.6 | 6.15 | 5.7 | 5.25 | 4.8 | 4.35 | 3.9 | 3.45 | 3 | 3 |
| TOPIX Index Futures | Equity Index | 2.35 | 2.2 | 2.05 | 1.9 | 1.75 | 1.6 | 1.45 | 1.3 | 1.15 | 1 | 1 |
| Australian Dollar Futures | Currency Index | 4.7 | 4.4 | 4.1 | 3.8 | 3.5 | 3.2 | 2.9 | 2.6 | 2.3 | 2 | 2 |
| British Pounds Sterling Futures | Currency Index | 4.7 | 4.4 | 4.1 | 3.8 | 3.5 | 3.2 | 2.9 | 2.6 | 2.3 | 2 | 2 |
| Canadian Dollar Futures | Currency Index | 3.525 | 3.3 | 3.075 | 2.85 | 2.625 | 2.4 | 2.175 | 1.95 | 1.725 | 1.5 | 1.5 |
| Euro Futures | Currency Index | 2.35 | 2.2 | 2.05 | 1.9 | 1.75 | 1.6 | 1.45 | 1.3 | 1.15 | 1 | 1 |
| Japanese Yen Futures | Currency Index | 2.35 | 2.2 | 2.05 | 1.9 | 1.75 | 1.6 | 1.45 | 1.3 | 1.15 | 1 | 1 |
| Swiss Franc Futures | Currency Index | 2.35 | 2.2 | 2.05 | 1.9 | 1.75 | 1.6 | 1.45 | 1.3 | 1.15 | 1 | 1 |

*The Composite Index contains all of the above contracts.
**The RBOB gasoline contract is proxied by the NY Unleaded gasoline (HUA Comdty) prior to September 2006.

TABLE A.4
Transaction commission cost assumptions used in the calculation of the StableRisk Trend Indices,
valued in US dollars, per contract, by historical year of the index. Values for years after 2010 will be
determined by the Index Committee.
Transaction Commission Costs in Dollars, By Contract, by Year

| Contract Name | Index* | 2000 | 2001 | 2002 | 2003 | 2004 | 2005 | 2006 | 2007 | 2008 | 2009 | 2010 |
|---|---|---|---|---|---|---|---|---|---|---|---|---|
| 10-Year Commonwealth Treasury Bond Futures | Interest Rates Index | 11.54 | 10.80 | 10.07 | 9.33 | 8.59 | 7.86 | 7.12 | 6.38 | 5.65 | 4.91 | 4.91 |
| 2-Year US Treasury Note Futures | Interest Rates Index | 4.70 | 4.40 | 4.10 | 3.80 | 3.50 | 3.20 | 2.90 | 2.60 | 2.30 | 2.00 | 2.00 |
| 3-Month (Short) Sterling Interest Rate Futures | Interest Rates Index | 4.70 | 4.40 | 4.10 | 3.80 | 3.50 | 3.20 | 2.90 | 2.60 | 2.30 | 2.00 | 2.00 |
| 3-Month Euro Euribor Interest Rate Futures | Interest Rates Index | 6.53 | 6.12 | 5.70 | 5.28 | 4.87 | 4.45 | 4.03 | 3.61 | 3.20 | 2.78 | 2.78 |
| 3-Month Euro Swiss Franc Interest Rate Futures | Interest Rates Index | 6.53 | 6.12 | 5.70 | 5.28 | 4.87 | 4.45 | 4.03 | 3.61 | 3.20 | 2.78 | 2.78 |
| 3-Month Euroyen Futures | Interest Rates Index | 6.53 | 6.12 | 5.70 | 5.28 | 4.87 | 4.45 | 4.03 | 3.61 | 3.20 | 2.78 | 2.78 |
| 3-Year Commonwealth Treasury Bond Futures | Interest Rates Index | 11.54 | 10.80 | 10.07 | 9.33 | 8.59 | 7.86 | 7.12 | 6.38 | 5.65 | 4.91 | 4.91 |
| 30-Day Federal Fund Rate Futures | Interest Rates Index | 6.53 | 6.12 | 5.70 | 5.28 | 4.87 | 4.45 | 4.03 | 3.61 | 3.20 | 2.78 | 2.78 |
| 30-Day ASX Interbank Cash Rate Futures | Interest Rates Index | 6.53 | 6.12 | 5.70 | 5.28 | 4.87 | 4.45 | 4.03 | 3.61 | 3.20 | 2.78 | 2.78 |
| 90-Day EuroDollar Time Deposit Futures | Interest Rates Index | 4.70 | 4.40 | 4.10 | 3.80 | 3.50 | 3.20 | 2.90 | 2.60 | 2.30 | 2.00 | 2.00 |
| ASX 90-Day Bank Accepted Bills Futures | Interest Rates Index | 4.70 | 4.40 | 4.10 | 3.80 | 3.50 | 3.20 | 2.90 | 2.60 | 2.30 | 2.00 | 2.00 |
| 5-Year US Treasury Note Futures | Interest Rates Index | 4.70 | 4.40 | 4.10 | 3.80 | 3.50 | 3.20 | 2.90 | 2.60 | 2.30 | 2.00 | 2.00 |
| Canadian 10 Year Bond Futures | Interest Rates Index | 6.65 | 6.23 | 5.80 | 5.38 | 4.95 | 4.53 | 4.10 | 3.68 | 3.25 | 2.83 | 2.83 |
| Canadian 3-Month Bankers Acceptance Futures | Interest Rates Index | 6.53 | 6.12 | 5.70 | 5.28 | 4.87 | 4.45 | 4.03 | 3.61 | 3.20 | 2.78 | 2.78 |
| Euro-Bobl Bond Futures | Interest Rates Index | 6.53 | 6.12 | 5.70 | 5.28 | 4.87 | 4.45 | 4.03 | 3.61 | 3.20 | 2.78 | 2.78 |
| Euro-Bund Bond Futures | Interest Rates Index | 6.53 | 6.12 | 5.70 | 5.28 | 4.87 | 4.45 | 4.03 | 3.61 | 3.20 | 2.78 | 2.78 |
| Euro-Schatz Bond Futures | Interest Rates Index | 6.53 | 6.12 | 5.70 | 5.28 | 4.87 | 4.45 | 4.03 | 3.61 | 3.20 | 2.78 | 2.78 |
| Japanese 10-Year Bond Futures (JGB) | Interest Rates Index | 26.56 | 24.86 | 23.17 | 21.47 | 19.78 | 18.08 | 16.39 | 14.6 | 13.00 | 11.30 | 11.30 |
| Long Gilt Futures | Interest Rates Index | 6.37 | 5.96 | 5.56 | 5.15 | 4.74 | 4.34 | 3.93 | 3.52 | 3.12 | 2.71 | 2.71 |
| New Zealand 90-Day Bank Bill Futures | Interest Rates Index | 6.53 | 6.12 | 5.70 | 5.28 | 4.87 | 4.45 | 4.03 | 3.61 | 3.20 | 2.78 | 2.78 |
| US 10-Year Treasury Note Futures | Interest Rates Index | 4.70 | 4.40 | 4.10 | 3.80 | 3.50 | 3.20 | 2.90 | 2.60 | 2.30 | 2.00 | 2.00 |
| US 30-Year Long Bond Futures | Interest Rates Index | 4.70 | 4.40 | 4.10 | 3.80 | 3.50 | 3.20 | 2.90 | 2.60 | 2.30 | 2.00 | 2.00 |
| Brent Crude Oil Futures | Commodity Index | 10.46 | 9.79 | 9.12 | 8.46 | 7.79 | 7.12 | 6.45 | 5.79 | 5.12 | 4.45 | 4.45 |
| Coffee ‘C’ Futures | Commodity Index | 14.22 | 13.31 | 12.40 | 11.50 | 10.59 | 9.68 | 8.77 | 7.87 | 6.96 | 6.05 | 6.05 |
| Copper Futures | Commodity Index | 5.29 | 4.95 | 4.61 | 4.28 | 3.94 | 3.60 | 3.26 | 2.93 | 2.59 | 2.25 | 2.25 |
| Corn Futures | Commodity Index | 9.75 | 9.13 | 8.51 | 7.89 | 7.26 | 6.64 | 6.02 | 5.40 | 4.77 | 4.15 | 4.15 |
| Gasoil (IPE) Futures | Commodity Index | 10.46 | 9.79 | 9.12 | 8.46 | 7.79 | 7.12 | 6.45 | 5.79 | 5.12 | 4.45 | 4.45 |
| Gasoline RBOB Futures** | Commodity Index | 11.40 | 10.67 | 9.94 | 9.22 | 8.49 | 7.76 | 7.03 | 6.31 | 5.58 | 4.85 | 4.85 |
| Gold 100 Oz Futures | Commodity Index | 9.05 | 8.47 | 7.89 | 7.32 | 6.74 | 6.16 | 5.58 | 5.01 | 4.43 | 3.85 | 3.85 |
| Heating Oil Futures | Commodity Index | 11.40 | 10.67 | 9.94 | 9.22 | 8.49 | 7.76 | 7.03 | 6.31 | 5.58 | 4.85 | 4.85 |
| Live Cattle Futures | Commodity Index | 10.32 | 9.66 | 9.00 | 8.34 | 7.68 | 7.02 | 6.37 | 5.71 | 5.05 | 4.39 | 4.39 |
| Natural Gas Futures | Commodity Index | 11.40 | 10.67 | 9.94 | 9.22 | 8.49 | 7.76 | 7.03 | 6.31 | 5.58 | 4.85 | 4.85 |
| Primary Nickel Futures | Commodity Index | 5.29 | 4.95 | 4.61 | 4.28 | 3.94 | 3.60 | 3.26 | 2.93 | 2.59 | 2.25 | 2.25 |
| Primary Aluminum Futures | Commodity Index | 5.29 | 4.95 | 4.61 | 4.28 | 3.94 | 3.60 | 3.26 | 2.93 | 2.59 | 2.25 | 2.25 |
| Silver 5000 Oz Futures | Commodity Index | 7.05 | 6.60 | 6.15 | 5.70 | 5.25 | 4.80 | 4.35 | 3.90 | 3.45 | 3.00 | 3.00 |
| Soybean Futures | Commodity Index | 10.01 | 9.37 | 8.73 | 8.09 | 7.46 | 6.82 | 6.18 | 5.54 | 4.90 | 4.26 | 4.26 |
| Soybean Meal Futures | Commodity Index | 9.75 | 9.13 | 8.51 | 7.89 | 7.26 | 6.64 | 6.02 | 5.40 | 4.77 | 4.15 | 4.15 |
| Soybean Oil Futures | Commodity Index | 9.75 | 9.13 | 8.51 | 7.89 | 7.26 | 6.64 | 6.02 | 5.40 | 4.77 | 4.15 | 4.15 |
| Sugar #11 Futures | Commodity Index | 7.76 | 7.26 | 6.77 | 6.27 | 5.78 | 5.28 | 4.79 | 4.29 | 3.80 | 3.30 | 3.30 |
| Wheat Futures | Commodity Index | 9.75 | 9.13 | 8.51 | 7.89 | 7.26 | 6.64 | 6.02 | 5.40 | 4.77 | 4.15 | 4.15 |
| WTI Crude Oil Futures | Commodity Index | 11.40 | 10.67 | 9.94 | 9.22 | 8.49 | 7.76 | 7.03 | 6.31 | 5.58 | 4.85 | 4.85 |
| Zinc Futures | Commodity Index | 5.29 | 4.95 | 4.61 | 4.28 | 3.94 | 3.60 | 3.26 | 2.93 | 2.59 | 2.25 | 2.25 |
| Amsterdam Exchange Index Futures | Equity Index | 15.23 | 14.26 | 13.28 | 12.31 | 11.34 | 10.37 | 9.40 | 8.42 | 7.45 | 6.48 | 6.48 |
| CAC 40 10 Euro Index Futures | Equity Index | 7.26 | 6.80 | 6.33 | 5.87 | 5.41 | 4.94 | 4.48 | 4.02 | 3.55 | 3.09 | 3.09 |
| DAX Index Futures | Equity Index | 7.99 | 7.48 | 6.97 | 6.46 | 5.95 | 5.44 | 4.93 | 4.42 | 3.91 | 3.40 | 3.40 |
| E-mini Dow Jones Industrial Average Futures | Equity Index | 5.78 | 5.41 | 5.04 | 4.67 | 4.31 | 3.94 | 3.57 | 3.20 | 2.83 | 2.46 | 2.46 |
| E-mini NASDAQ 100 Index Futures | Equity Index | 6.32 | 5.92 | 5.51 | 5.11 | 4.71 | 4.30 | 3.90 | 3.50 | 3.09 | 2.69 | 2.69 |
| E-mini S&P 500 Index Futures | Equity Index | 5.29 | 4.95 | 4.61 | 4.28 | 3.94 | 3.60 | 3.26 | 2.93 | 2.59 | 2.25 | 2.25 |
| E-mini S&P Midcap 400 Futures | Equity Index | 6.32 | 5.92 | 5.51 | 5.11 | 4.71 | 4.30 | 3.90 | 3.50 | 3.09 | 2.69 | 2.69 |
| EURO STOXX 50 Index Futures | Equity Index | 3.64 | 3.41 | 3.18 | 2.95 | 2.71 | 2.48 | 2.25 | 2.02 | 1.78 | 1.55 | 1.55 |
| FTSE 100 Index Futures | Equity Index | 0.38 | 0.35 | 0.33 | 0.30 | 0.28 | 0.26 | 0.23 | 0.21 | 0.18 | 0.16 | 0.16 |
| FTSE JSE Top 40 Index Futures | Equity Index | 15.23 | 14.26 | 13.28 | 12.31 | 11.34 | 10.37 | 9.40 | 8.42 | 7.45 | 6.48 | 6.48 |
| FTSE MIB Index Futures | Equity Index | 15.23 | 14.26 | 13.28 | 12.31 | 11.34 | 10.37 | 9.40 | 8.42 | 7.45 | 6.48 | 6.48 |
| Hang Seng Enterprise Index Futures | Equity Index | 15.28 | 14.30 | 13.33 | 12.35 | 11.38 | 10.40 | 9.43 | 8.45 | 7.48 | 6.50 | 6.50 |
| Hang Seng Index Futures | Equity Index | 15.28 | 14.30 | 13.33 | 12.35 | 11.38 | 10.40 | 9.43 | 8.45 | 7.48 | 6.50 | 6.50 |
| IBEX 35 Index Futures | Equity Index | 11.75 | 11.00 | 10.25 | 9.50 | 8.75 | 8.00 | 7.25 | 6.50 | 5.75 | 5.00 | 5.00 |
| MSCI Taiwan Stock Index Futures | Equity Index | 5.88 | 5.50 | 5.13 | 4.75 | 4.38 | 4.00 | 3.63 | 3.25 | 2.88 | 2.50 | 2.50 |
| Nikkei 225 (OSE) Index Futures | Equity Index | 23.50 | 22.00 | 20.50 | 19.00 | 17.50 | 16.00 | 14.50 | 13.0 | 11.50 | 10.00 | 10.00 |
| OMXS30 Index Futures | Equity Index | 7.05 | 6.60 | 6.15 | 5.70 | 5.25 | 4.80 | 4.35 | 3.90 | 3.45 | 3.00 | 3.00 |
| E-mini Russell 200 Index Futures | Equity Index | 6.32 | 5.92 | 5.51 | 5.11 | 4.71 | 4.30 | 3.90 | 3.50 | 3.09 | 2.69 | 2.69 |
| S&P TSX 60 Index Futures | Equity Index | 8.60 | 8.05 | 7.50 | 6.95 | 6.41 | 5.86 | 5.31 | 4.76 | 4.21 | 3.66 | 3.66 |
| ASX SPI 200 Index Futures | Equity Index | 13.30 | 12.45 | 11.60 | 10.75 | 9.91 | 9.06 | 8.21 | 7.36 | 6.51 | 5.66 | 5.66 |
| TOPIX Index Futures | Equity Index | 31.87 | 29.83 | 27.80 | 25.76 | 23.73 | 21.70 | 19.66 | 17.6 | 15.59 | 13.56 | 13.56 |
| Australian Dollar Futures | Currency Index | 2.12 | 1.98 | 1.85 | 1.71 | 1.58 | 1.44 | 1.31 | 1.17 | 1.04 | 0.90 | 0.90 |
| British Pounds Sterling Futures | Currency Index | 3.06 | 2.86 | 2.67 | 2.47 | 2.28 | 2.08 | 1.89 | 1.69 | 1.50 | 1.30 | 1.30 |
| Canadian Dollar Futures | Currency Index | 2.35 | 2.20 | 2.05 | 1.90 | 1.75 | 1.60 | 1.45 | 1.30 | 1.15 | 1.00 | 1.00 |
| Euro Futures | Currency Index | 4.23 | 3.96 | 3.69 | 3.42 | 3.15 | 2.88 | 2.61 | 2.34 | 2.07 | 1.80 | 1.80 |
| Japanese Yen Futures | Currency Index | 3.06 | 2.86 | 2.67 | 2.47 | 2.28 | 2.08 | 1.89 | 1.69 | 1.50 | 1.30 | 1.30 |
| Swiss Franc Futures | Currency Index | 2.82 | 2.64 | 2.46 | 2.28 | 2.10 | 1.92 | 1.74 | 1.56 | 1.38 | 1.20 | 1.20 |

*The Composite Index contains all of the above contracts.
**The RBOB gasoline contract is proxied by the NY Unleaded gasoline (HUA Comdty) prior to September 2006.

The invention described above is operational with general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

Components of the inventive computer system may include, but are not limited to, a processing unit, a system memory, and a system bus that couples various system components including the system memory to the processing unit. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system typically includes a variety of non-transitory computer-readable media. Computer-readable media can be any available media that can be accessed by the computer and includes both volatile and nonvolatile media, and removable and non-removable media. By way of example, and not limitation, computer-readable media may comprise computer storage media and communication media. Computer storage media may store information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The computer system may operate in a networked environment using logical connections to one or more remote computers. The remote computer may be a personal computer, a server, a router, a network PC, a peer device or other common network node, and typically includes many or all of the elements described above relative to the computer. The logical connections depicted in include one or more local area networks (LAN) and one or more wide area networks (WAN), but may also include other networks. Such networking environments are commonplace in offices, enterprise-wide computer networks, intranets and the Internet.

For ease of exposition, not every step or element of the present invention is described herein as part of software or computer system, but those skilled in the art will recognize that each step or element may have a corresponding computer system or software component. Such computer systems and/or software components are therefore enabled by describing their corresponding steps or elements (that is, their functionality), and are within the scope of the present invention. In addition, various steps and/or elements of the present invention may be stored in a non-transitory storage medium, and selectively executed by a processor.

While the invention has been particularly shown and described with reference to a preferred embodiment, it will be understood by those skilled in the art that various changes in form and detail may be made therein without departing from the spirit and scope of the invention.

What is claimed is:

1. A computer system comprising:
a data tracking module for receiving select trade and price data associated with plural future contracts and organizing said trade and price data into compiled attenuated risk portfolio;
an index determination processor for selectively assessing a measure of said risk attenuated portfolio;
a trending processor for determining the pricing trends for each asset; and
a report generator for developing an output presentation of said index based on a portfolio of investments characterized by a select volatility and said portfolio is dynamically rebalanced on a periodic basis by the purchase and/or sale of futures contracts.

2. A computer implemented method for maintaining the short term risk of asset classes, within an investment portfolio, at or near the long term volatility level of said asset classes, comprising:
identifying eligible future contracts based on a minimum average daily dollar trading volume and regulatory restrictions;
calculating the volatility target level for each asset class using the average volatility for traditional long-only indexes representing each asset class for a predefined trailing period, wherein said asset classes include equity, interest rate, currency, and commodity;
stabilizing the volatility of each asset class at said target level by modulating the market exposure of each asset class;
determining the directional position of each asset by comparing a short term trailing period average price to a longer term trailing period average price;
holding assets with a positive directional position long, and assets with a negative direction position short;
determining constituent asset weights by combing risk allocation information and said directional positions, with short term risk estimates of each index's constituent assets;
rescaling the risk allocation among asset classes; and
combining said rescaled asset classes into a composite index.

3. The computer implemented method of claim 2, wherein said predefined trailing period is 10-years.

4. The computer implemented method of claim 2, wherein said modulation of market exposure of each asset class is inversely proportional to the short term volatility for that asset class.

5. The computer implemented method of claim 2, further comprising the step of allocating risk among constituent assets within an asset class.

6. The computer implemented method of claim 5, wherein said risk is allocated equally among constituent assets within said asset class.

7. The computer implemented method of claim 2, further comprising the step of determining trading costs.

8. The computer implemented method of claim 2, wherein said short term trailing period is one month.

9. The computer implemented method of claim 8, wherein said longer term trailing period is twelve months.
